(19) United States
(12) Patent Application Publication
(10) Pub. No.: US 2025/0114273 A1
(43) Pub. Date: Apr. 10, 2025

(54) DEVICE AND METHOD FOR RELIEVING HEADACHES

(71) Applicant: JOSHUA R. GRAY, IRMO, SC (US)

(72) Inventor: JOSHUA R. GRAY, IRMO, SC (US)

(21) Appl. No.: 18/910,812

(22) Filed: Oct. 9, 2024

Related U.S. Application Data
(60) Provisional application No. 63/589,045, filed on Oct. 10, 2023.

(51) Int. Cl. A61H 39/04; A61H 39/00; A61H 39/06

(52) U.S. Cl. CPC A61H 39/04; A61H 39/007; A61H 39/06; A61H 2201/0153; A61H 2201/0207; A61H 2201/10; A61H 2201/1638; A61H 2205/065

(57) ABSTRACT

A device for applying pressure to a physiological pressure point such as the Hegu pressure point, has opposing spring biased jaws in a pivoting relationship. A variable pressure actuator moves a first jaw toward a second jaw and retracts the first jaw from the second jaw. In an application, the second jaw contacts a palm of a hand of a user, and the first jaw contacts an opposite side of the hand of the user, and the jaws cooperate to apply pressure at a physiological pressure point of the hand.

Applicant claims the benefit of Provisional Application Ser. No. 63/589,045 filed Oct. 10, 2023.

### BACKGROUND OF THE INVENTION

In the United States of America, there are an estimated 40 million migraine headache sufferers. For many people who suffer from these attacks, the experience can be incredibly uncomfortable to the point of debilitation. There are a variety of treatment methods for migraine headaches, but many of them require medication and can take hours to bring about significant results. Many sufferers are resistant to these techniques, or do not wish to use them from a desire to use holistic approaches as opposed to pharmaceutical intervention or Botox injection, for example.

Pressure point LI-4 is also called Hegu. This pressure point is found on the back of the hand between the base of the thumb and index finger. Acupressure on this point can help with pain and headaches. Prolonged manipulation of this pressure point requires another person to continuously apply pressure to the LI-4 point, with the secondary challenge that the assistant may become fatigued before adequate relief is achieved.

### SUMMARY OF THE INVENTION

A device for applying pressure to a physiological pressure point such as the Hegu pressure point, has opposing spring biased jaws in a pivoting relationship. A variable pressure actuator moves a first jaw toward a second jaw and retracts the first jaw from the second jaw. In an application, the second jaw contacts a palm of a hand of a user, and the first jaw contacts an opposite side of the hand of the user, and the jaws cooperate to apply pressure at a physiological pressure point of the hand.

The invention manipulates the LI-4 (“Hegu”) pressure point (the “Pressure Point”) in the hand by applying variable and customizable pressure at the Pressure Point. The amount of pressure may be adjusted to meet efficacy needs of an individual suffering a migraine, both initially, and between or during treatments.

### BRIEF DESCRIPTION OF THE DRAWINGS

FIG. 1 is perspective view of the device according to an embodiment of the invention with spring biased jaws in a relatively open position.

FIG. 2 is another perspective view of the device according to an embodiment of the invention with spring biased jaws in a relatively open position.

FIG. 3 is perspective view of the device according to an embodiment of the invention with variable pressure actuator inserted into one of the spring biased jaws to partially close the spring biased jaws.

FIG. 4 demonstrates the device according to an embodiment of the invention positioned relative on a hand, with the spring biased jaws in an open position.

FIG. 5 demonstrates the device according to an embodiment of the invention with spring biased jaws positioned with the variable pressure actuator forcing the jaws closer together relative to the pressure point LI-4.

FIG. 6 demonstrates the device according to an embodiment of the invention with the variable pressure actuator forcing the jaws closer together than in FIG. 5.

### EMBODIMENTS OF THE INVENTION

The invention manipulates the LI-4 (“Hegu”) pressure point in the hand by applying variable and customizable pressure at the Pressure Point. The amount of pressure may be adjusted to meet efficacy needs of an individual suffering a migraine, both initially, and between or during treatments. In a preferred embodiment, a variable pressure actuator with a quick-release mechanism applies a controlled, variable pressure force to the Pressure Point. The pressure on the Pressure Point may be sustained for an extended period of time, or adjusted periodically. Preferably, a quick release is provided to prevent the user from becoming overwhelmed or experiencing undue pain during use.

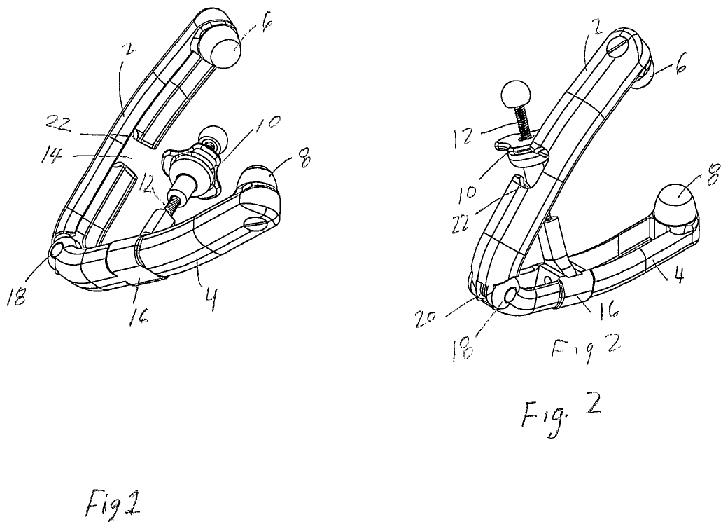

Turning to the drawing figures, the device provides a first arm 2 and a second arm 4 that are joined in a pivoting relationship 18 at one end of each arm to form jaws. The first arm and the second arm are in a spring biased 20 relationship so that the jaws are urged away from each other, with the travel of the jaws limited. FIG. 1 shows the jaws in a fully open relationship, being urged away from each other by spring biasing, but limited in the degree of movement.

Each arm 2,4 has a tip 6,8 for concentrating pressure. The tips are present near the active end of each arm and generally opposite the pivot point. In one embodiment, the tips are preferred to be formed of a resilient material such as rubber, silicone or elastomer. The active end may comprise exchangeable, customizable, contact tips. The tips are formed as points extending from the jaws so as to concentrate the pressure provided from the opposing and spring biased jaws.

The variable pressure actuator in one embodiment has a threaded collar 10 that travels along the threads 12 of a screw. Rotation of the threaded collar moves the collar of the variable pressure actuator along the screw.

The variable pressure actuator comprises a pivot point 16 on one end, where the variable pressure actuator is connected to the second arm. The pivot point allows the screw assembly to rotate relative to the second arm.

The first arm 2 has a slot 14 formed in it. The slot is open on one side. The jaws can be moved so that the collar 10 is placed within the slot. The slot is preferred to have a radiused part 22 on each side into which the arcuate surface of the collar is positioned to assist in retaining the collar in the slot.

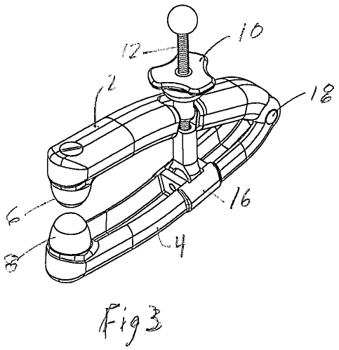

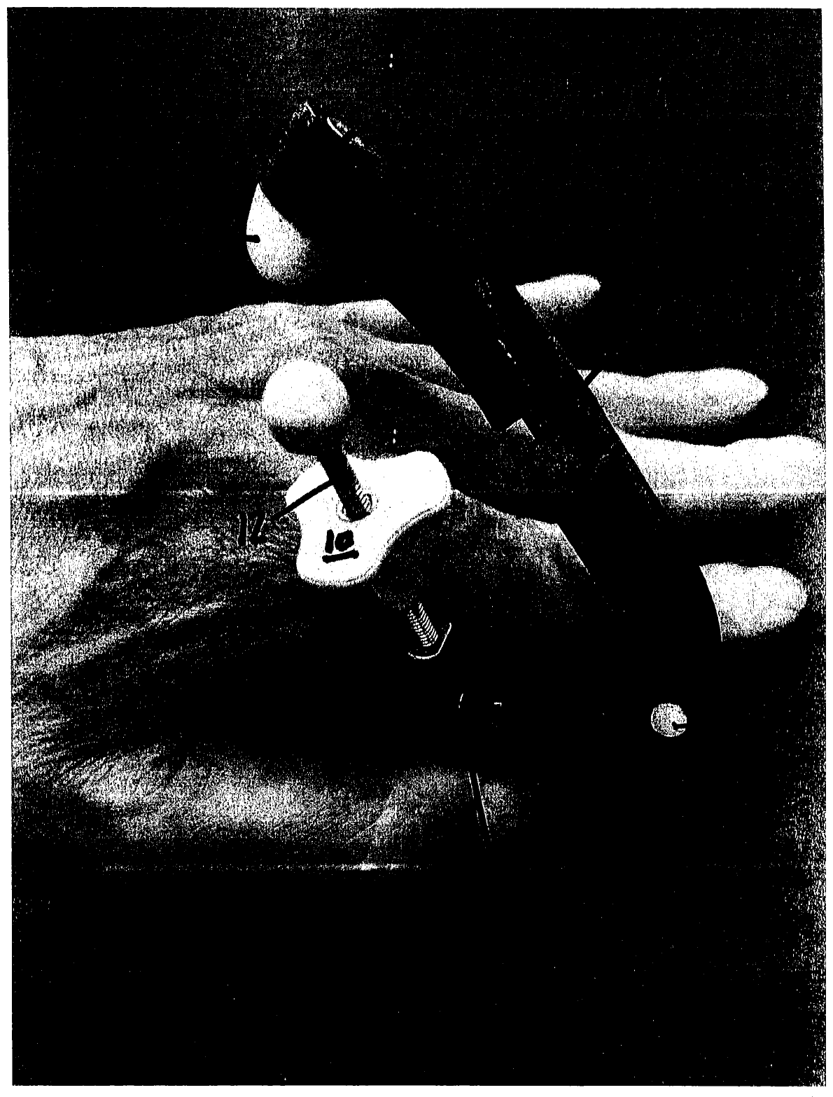

As the collar 10 is rotated in one direction while in the slot 14, the collar moves along the threads 12 and toward second arm 4, moving the first arm closer to the second arm. Note the positions of the collar on the threads in FIG. 2 and FIG. 3. The jaws are closer together due to the pressure that the collar applies to the jaws that are in a pivoting relationship. Pressing the jaws together allows the collar to slide out of the slot so that spring biasing moves the jaws to the fully open position as limited. This feature allows the device to be quickly removed from the Pressure Point, while maintaining a position for use that limits the amount of rotation required for applying pressure when used again.

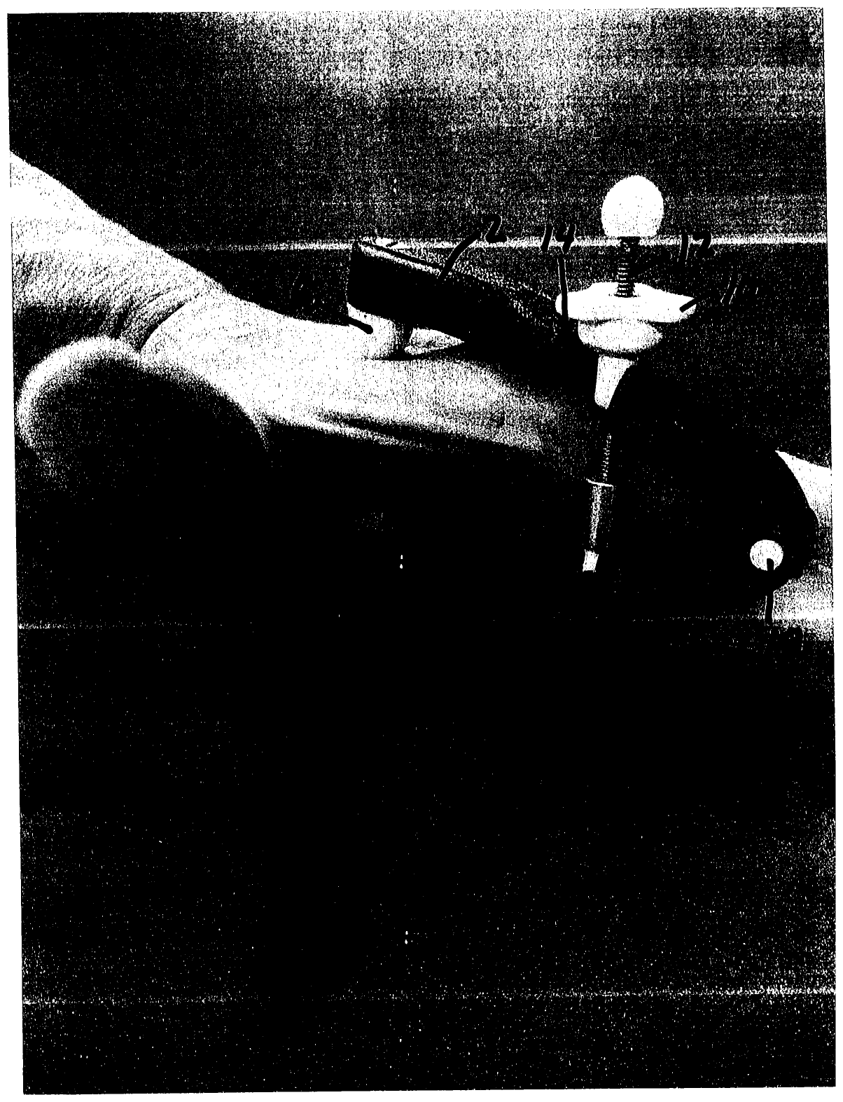

FIGS. 4, 5 and 6 demonstrate a method of using the invention. As shown in FIG. 4, the second arm 4 is positioned under the palm of the hand. The variable pressure actuator is removed from the slot 14 so that the spring biased jaws 2,4 are fully opened.

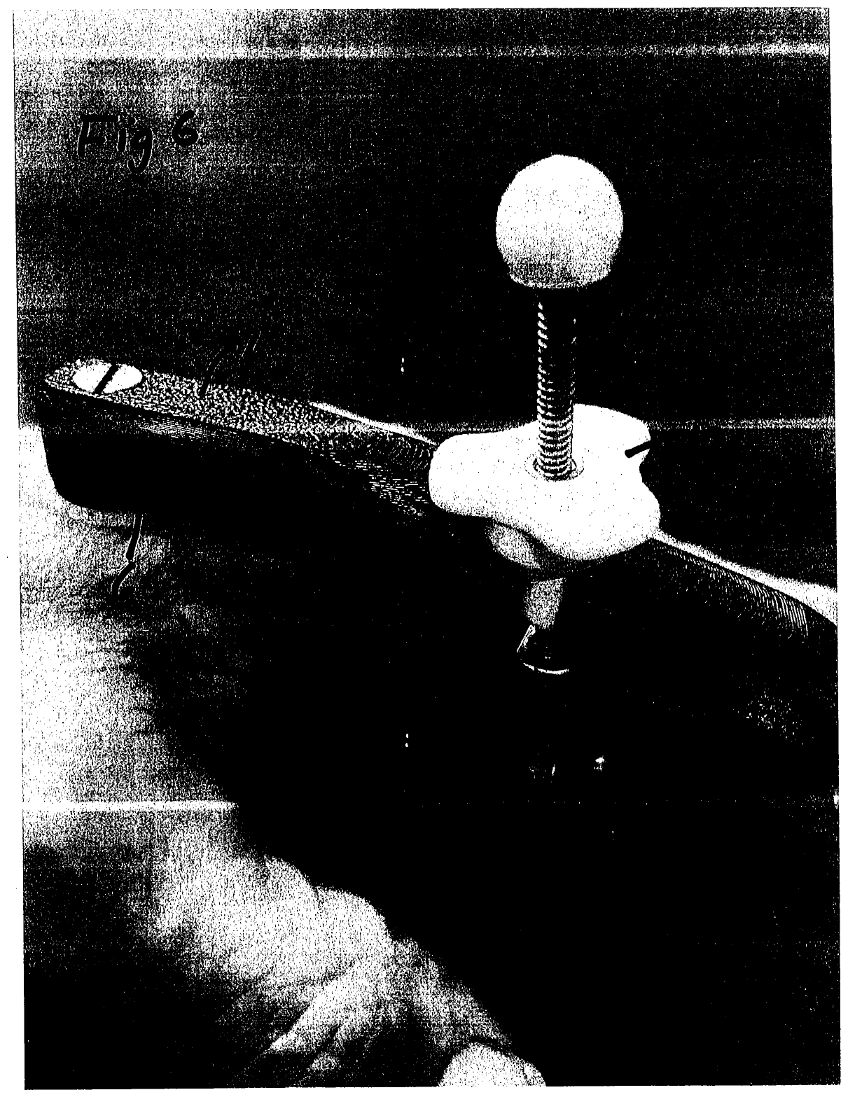

FIG. 5 shows the variable pressure actuator with the collar 10 positioned in the slot 14 to apply pressure to the first arm 2. The first arm and the second arm 4 are closer together due to the pressure applied to the first arm by the collar as the collar is advanced toward the second arm. Pressure is applied through the tip 6 of the first arm to the LI-4 Pressure Point.

FIG. 6 shows the collar 10 of the variable pressure actuator further advanced along the threaded member 12 to apply additional pressure to the LI-4 Pressure Point. The collar has moved lower relative to the threaded member. If the additional pressure is uncomfortable, the user may reverse the travel of the collar to reduce the pressure. In some cases, the user may alternate between greater pressure and lesser pressure to achieve the desired results.

In another embodiment, tips 6,8 apply heat and/or cold, vibration, electrostatic stimulation, essential oil application or other options. Remote control of an actuator may be provided to manipulate the application of pressure and the amount of pressure. For example, an actuator may cyclically apply and relieve pressure, applying pressure for a desired time and relieving pressure for a desired time. The device may be adapted to target other pressure points on the human body, such as pressure points on the foot.

In a preferred embodiment, each arm 2,4 of the device is approximately 3″-6″ (7.5 to 16 cm) in length and fits a wide variety of hand dimensions. The arms need not be of equal length. The second arm that is positioned under the palm of hand may be longer than the first arm to help hold the device in place.

Components of the device may be molded or printed from a conformable polylactide (PLA) or other plastic material, which is fitted over a solid backbone (which may be stainless steel or similar rigid material) so that a tailored mixture of a structurally strong support device is maintained while also providing a pleasant tactile experience.

In other embodiments the contact tips 6,8 may be held in place by a set of magnetic contact points, or a set of snap-on, interference fit locks, or a set of sliding ridges, or similar attachment constructs. The contact tips may be permanently attached to the arms for a non-exchangeable version of the device in another embodiment. The contact tips may range in size to fit a variety of hand dimensions. The contact tips may be formed of metal, polymeric or ceramic material, or rigid thermoplastic. The contact tips may be subjected to temperatures below 0° C. prior to application, providing a cold sensory experience to the user.

In another embodiment, at least the contact tip 6 on the first arm 2 provides heat to the tips during application. For example, the contact tips may be formed of materials that are heated by microwave, infrared or resistance heating. Examples of materials for tips that may be heated are polymeric and ceramic materials.

In another embodiment, the contact tips 6,8 are vibrated. For example, a current is provided, such as by a small rechargeable battery encased in the handle end of the plier mechanism that provides adjustable levels of vibration. A resistor provided controlled by a dial or slide dictates the level vibration to a vibratory device or motor that communicates with the control tips. In another embodiment, a cell phone controls the vibratory device or motor by near field communications. Resistance heating may be similarly used and controlled, either with or separately from the vibratory device.

Variable pressure application is preferred. In one embodiment, the distal end of the device may have a set of plier-type fulcrum handles, combined with a threaded mechanism to allow for an approximate distance between the contact tips, which may then be fine-tuned by adjustment after initial positioning by manipulating the threaded member to move the contact tips closer together. Other mechanical structures that move and hold the jaws at user selected distances and pressures may be used.

The device may be fabricated from environmentally sustainable materials having a polymeric material coated over a rigid material, such as stainless steel, carbon fiber or plastic. Alternatively, the entire assembly may be fabricated from rigid plastic, carbon fiber or metal, or a softer, pliable material.

What is claimed is:

1. A device for applying pressure to a physiological pressure point, comprising:
a first jaw;
a second jaw that opposes the first jaw and is in a pivoting and spring biased relationship relative to the first jaw; and
a variable pressure actuator that moves the first jaw toward the second jaw and retracts the first jaw from the second jaw;
wherein the second jaw is constructed and arranged to contact a palm of a hand of a user, and the first jaw is constructed and arranged to contact an opposite side of the hand of the user, and the first jaw and the second jaw cooperate to apply pressure at a physiological pressure point of the hand.

2. The device for applying pressure to a physiological pressure point as described in claim 1, further comprising a first tip for concentrating pressure extending from the first jaw and toward the second jaw, and a second tip for concentrating pressure extending from the second jaw and toward the first jaw, wherein the first tip and the second tip are constructed and arranged to cooperatively apply pressure at a physiological pressure point of the hand.

3. The device for applying pressure to a physiological pressure point as described in claim 1, wherein the variable pressure actuator extends from and pivots relative to the second jaw and is pivotable to contact the first jaw.

4. The device for applying pressure to a physiological pressure point as described in claim 1, wherein the variable pressure actuator extends from and pivots relative to the second jaw and is pivotable to contact the first jaw, and wherein the variable pressure actuator comprises a threaded member and a threaded collar.

5. The device for applying pressure to a physiological pressure point as described in claim 1, further comprising a quick release mechanism.

6. The device for applying pressure to a physiological pressure point as described in claim 1, wherein the variable pressure actuator extends from and pivots relative to the second jaw and is pivotable to contact the first jaw, and wherein the variable pressure actuator comprises a threaded member and a threaded collar, and wherein the threaded member is pivoted to be positioned within a slot formed in the first jaw, and the threaded collar is positioned above the slot holds the first jaw and the second jaw in relative position by the spring biased relationship, and wherein moving the variable pressure actuator out of the slot moves the first jaw and second jaw apart by the spring biased relationship.

7. The device for applying pressure to a physiological pressure point as described in claim 1, wherein the first tip and the second tip are heated.

8. The device for applying pressure to a physiological pressure point as described in claim 1, wherein the first tip and the second tip vibrate.

9. The device for applying pressure to a physiological pressure point as described in claim 6, wherein the slot opens to a side of the first jaw.
